(19) United States
(12) Patent Application Publication
(10) Pub. No.: US 2015/0042211 A1
(43) Pub. Date: Feb. 12, 2015

(54) System and method for generating electricity by an inflated moving wheel

(71) Applicant: Hongjun Pan, Lewisville, TX (US)

(72) Inventor: Hongjun Pan, Lewisville, TX (US)

(21) Appl. No.: 13/947,749

(22) Filed: Aug. 6, 2013

(51) Int. Cl. H02N 2/18

(52) U.S. Cl. CPC H02N 2/18
USPC 310/339

(57) ABSTRACT

A system and method for generating electricity by an inflated moving wheel for transportation devices is disclosed. In accordance with embodiments of the present disclosure, an electricity generating wheel may include an flexible inflated tire, a wheel rim, a central shaft, an electricity generator is installed inside of the inflated tire; the electricity generator may include an outer ring and an inner ring and multiple springs; the inner ring and outer ring may comprise multiple piezoelectricity generators (or other types of electricity generators), the springs connect the outer ring and the inner ring electricity generators and keep the outer ring in contact with the inner surface of the inflated tire. The weight and load of the transportation devices compresses the inflated tire, imposes compression force on the springs, the springs pass such compression force on the electricity generator, the electricity is generated, significant amount of energy is recovered and reused.

### REFERENCES CITED

### U.S. Patent Documents

U.S. Pat. No. 8,376,100 B2 February 2013 Avadhany et al.

### TECHNICAL FIELD

The present invention relates generally to transportation devices generating electricity, and more particularly to transportation devices generating electricity by piezoelectricity generator (or other types of electricity generators) installed inside of inflated wheels.

### BACKGROUND

At present time, most of motor vehicles are powered by combustion of gasoline. As population increases steadily, the number of motor vehicles is increases accordingly; this causes global warming and environment pollution. Electric and hybrid electric/combustion engine vehicles are developed as alternatives to reduce the global warming and pollution, those vehicles are getting more and more popular and will be dominant in the future. In 2012, US government issued the final version of new rules that require automakers to nearly double the average fuel economy of new cars and trucks by 2025. To achieve such goal, we have to dramatically improve the efficiency of the engine, power delivery system; we also have to recover as much wasted energy as possible. A typical example of recovering wasted energy is the “regenerative braking” technology which is used in hybrid automobiles to capture energy during braking; another example is the “Regenerative Shock Absorber” technology disclosed in the U.S. Pat. No. 8,376,100, which generates electricity by converting the kinetic energy of suspension travel into electricity. Such recovered electricity can be used to drive the vehicles in electric or hybrid motor vehicles.

It is therefore an object of the present invention to disclose a new system and method to recover the wasted energy and generate electricity by piezoelectricity generators (or other types of electricity generators) installed inside of inflated wheels under the weight compression force of the vehicles.

### SUMMARY

In accordance with the present disclosure, a new system and method to recover the energy and generate electricity for moving transportation devices is described.

In accordance with embodiments of the present disclosure, an electricity generating wheel may include an flexible inflated tire, a wheel rim, a central shaft, an electricity generator is installed inside of the inflated tire; the electricity generator may include an outer ring and an inner ring and multiple springs; the inner ring comprises multiple piezoelectricity generators (or other types of electricity generators), for the single side electricity generation design, the outer ring is just a flexible metal ring, the springs connect the outer ring and the piezoelectricity generators (or other types of electricity generators) and keep the outer ring in contact with the inner surface of the inflated tire; for double side electricity generation design, the outer ring comprises multiple piezoelectricity generators (or other types of electricity generators), the springs connect the piezoelectricity generators of the outer ring and the piezoelectricity generators (or other types of electricity generators) of the inner ring. The weight and load of the transportation devices will compress the inflated tire and make the ground contact portion of the tire flat and impose compression force on the springs, in the single side electricity generation design, the springs will pass such compression force on the piezoelectricity generators (or other types of electricity generators), therefore, the electricity will be generated by piezoelectricity generators (or other types of electricity generators); for double side electricity generation design, both piezoelectricity generators of outer ring and the piezoelectricity generators of the inner ring receive the same amount of compression force, this is based on the Newton's third Law of motion, therefore, both piezoelectricity generators of outer ring and the piezoelectricity generators of the inner ring generate electricity, so the same amount of force generates twice of the electricity. Furthermore, piezoelectricity generators (or other types of electricity generators) will generate more electricity when the driving on a rough road because the piezoelectricity generators (or other types of electricity generators) will receive more compression force caused by the vehicle vibration. The generated electricity will be delivered through electric conducting wires to batteries for storage or directly to the motor to drive the vehicle. With this invention, significant amount of energy will be recovered and reused; therefore, the energy efficiency of the transportation devices will be significantly improved.

### BRIEF DESPCRIPTION

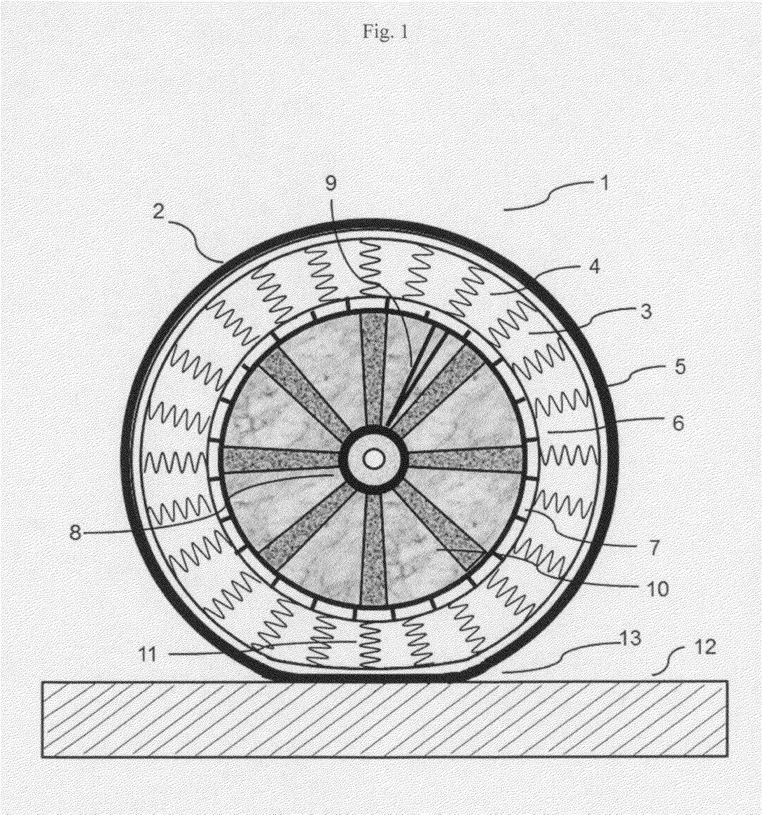

FIG. 1 is the cross section view of the structure and components of the single side electricity-generating wheel from the central circle plan.

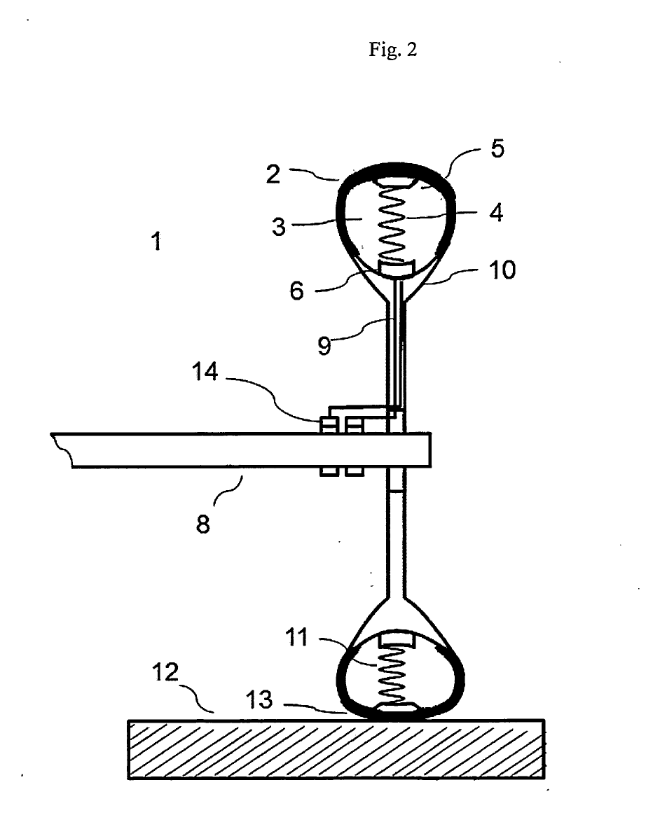

FIG. 2 is the cross section view of the structure and components of the single side electricity-generating wheel perpendicular to FIG. 1

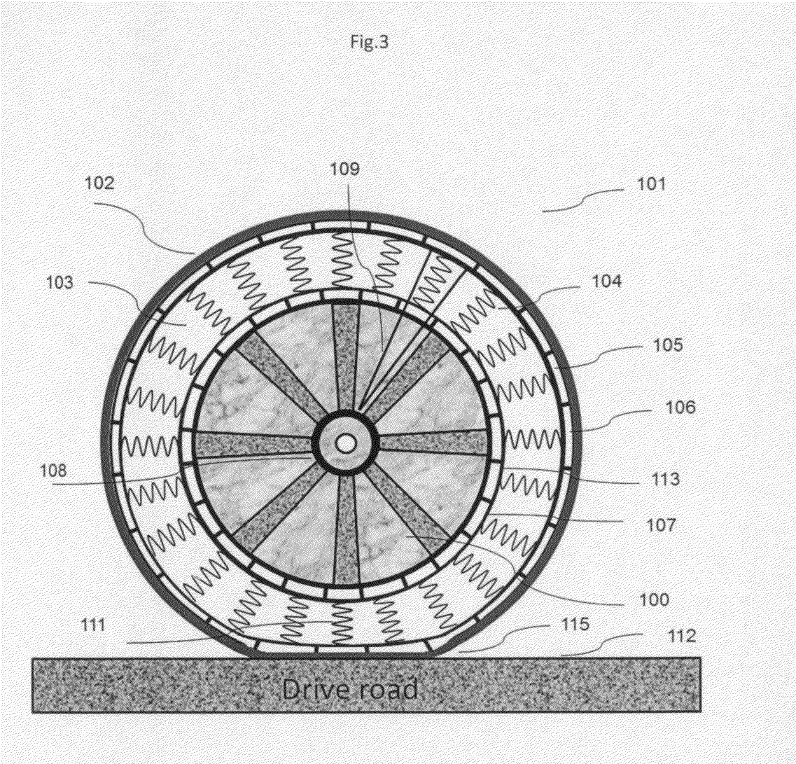

FIG. 3 is the cross section view of the structure and components of the double side electricity-generating wheel from the central circle plan.

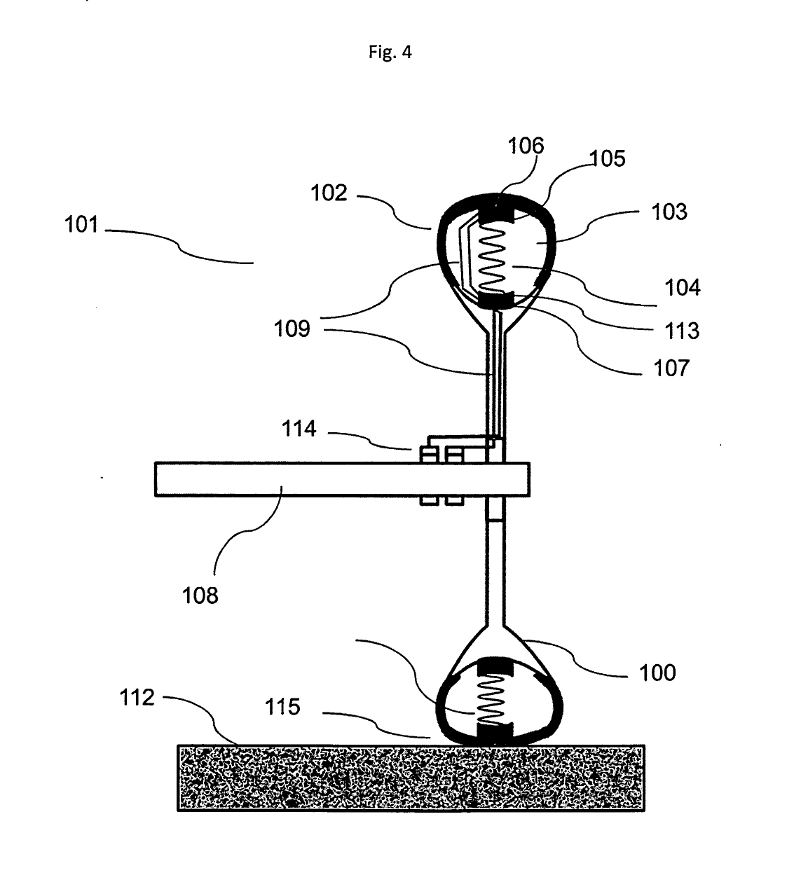

FIG. 4 is the cross section view of the structure and components of the double side electricity-generating wheel perpendicular to FIG. 3

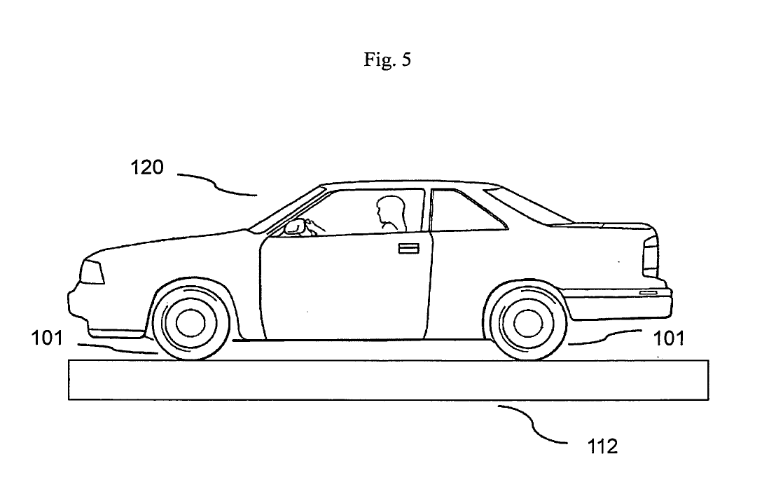

FIG. 5 demonstrates a vehicle installed with the electricity-generating wheels.

### DETAILED DESCRIPTION

FIG. 1 illustrates the components and the assembly of the present invention for the single side electricity generation wheel. The electricity-generating wheel 1 contains inflated tire 2, the rim 10 and central shaft 8, the electricity generator 3 is installed inside of the inflated tire, the electricity generator 3 includes a flexible outer metal ring 5, multiple metal springs 4 and an inner ring 6, the inner ring 6 consists multiple piezoelectricity generators 7 (or other types of electricity generators), the springs 4 connect the outer ring 5 and the piezoelectricity generators (or other types of electricity generators) and keep the outer ring 5 in contact with the inner surface of the tire 2; all piezoelectricity generators (or other types of electricity generators) are electrically connected together. When such the electricity-generating wheel 1 is installed to a transportation device (such as an automobile), the weight of the transportation device and its load will compress the inflated tire and make the ground-contact portion 13 of the wheel flat, this will compress the spring 11, the compressed spring 11 will pass the force to the piezoelectricity generators 7 (or other types of electricity generators) then, piezoelectricity generators 7 (or other types of electricity generators) will generate electricity, such electricity will be delivered to the battery or the electric motor by the electricity conducting wires 9 with electrical contact 14 in FIG. 2, such electrical contact 14 can be electric brush or other proper means.

FIG. 3 illustrates the components and the assembly of the present invention for the double side electricity generation wheel 101. In this configuration, the electricity-generating wheel 101 contains inflated tire 102, the rim 100 and central shaft 108, the electricity generator 103 is installed inside of the inflated tire, the electricity generator 103 includes a flexible outer ring 105, multiple metal springs 104 and an inner ring 7, the outer ring 105 comprises multiple piezoelectricity generators 106 (or other types of electricity generators), the springs 104 connect the piezoelectricity generators 106 of outer ring 105 and the piezoelectricity generators 113 of inner ring 107. The weight of the transportation device and its load will compress the inflated tire 102 and make the ground-contact portion 115 of the wheel flat, this will compress the spring 104, the compressed spring 104 will pass the force to the piezoelectricity generators 106 (or other types of electricity generators) and the piezoelectricity generators 113, then, piezoelectricity generators 106 and 113 (or other types of electricity generators) will generate electricity. Based on the Newton's third law of motion, the piezoelectricity generators 106 and 113 at the two ends of the springs receive the same amount of compression force, generate electricity, therefore, the output of electricity is doubled. This double side electricity generation configuration can be applied to other area such as walking way/drive way electricity generation using piezoelectricity generators. All piezoelectricity generators are electrically connected and the generated electricity is delivered to battery or the electric motor by electric conducting wires 109 as shown in FIG. 4.

When driving the transportation device, the wheel rotates, each piezoelectricity generator (or other types of electricity generators) will generate electricity without any additional energy, and in addition, the piezoelectricity generators (or other types of electricity generators) will receive more compression force due to vibration on a rough road. With this invention, significant amount of energy will be recovered to drive the transportation device, which will improve significantly the energy efficiency and the performance.

FIG. 5 illustrates a normal auto vehicle 120 installed with 4 such electricity-generating wheels.

The said electricity generating wheels can be also installed to motor cycles and motor bicycles and any other transportation devices with inflated wheels.

Another benefit of the present invention is that the basic structure of the electricity generating system can provide mechanical support to the wheels and prevent “flat tire” if the springs are mechanically strong enough to provide similar cushion and flexibility as the inflated rubble tire provides, so the wheels will never have flat tire even when the inflated tire loses air pressure due to the holes damaged by sharp objects or roadside explosive devices. This shall have great potential application in military vehicles. For military vehicles, preventing “flat tire” is the top priority, the “flat tire” during military actions may cause serious results (such as delay the military actions, turn around the win/loss in a battle or become the target of ambush).

It should be understood that the description of this invention is only for illustration of the idea of the electricity-generating wheel; many variation may be possibly made by professionals in this field without departing of the scope of the invention.

What is claimed is:

1. A transportation devices such as (but not limited to) automobiles, motorcycle, bicycles with electricity-generating wheels.

2. The said electricity-generating wheel comprising:
a flexible inflated tire, a wheel rim, a central shaft, an electricity generator installed inside of the inflated tire.

3. The said electricity generator comprising:
an outer ring, multiple springs and an inner ring, the said inner ring consists multiple piezoelectricity generators (or other types of electricity generators), the springs connect the outer ring and the piezoelectricity generators (or other types of electricity generators) and keep the outer ring in contact with the inner surface of the inflated tire. Electric conducting wires connect the piezoelectricity generators (or other types of electricity generators) to an electric contact to deliver the electricity generated by piezoelectricity generators (or other types of electricity generators) to a battery or other electricity-consuming devices.

4. The said electricity generator comprising:
an outer ring, multiple springs and an inner ring, the said inner ring consists multiple piezoelectricity generators (or other types of electricity generators), the outer ring comprises multiple piezoelectricity generators (or other types of electricity generators), the springs connect the piezoelectricity generators (or other types of electricity generators) of outer ring and the piezoelectricity generators (or other types of electricity generators) of inner ring and keep the outer ring in contact with the inner surface of the inflated tire. Electric conducting wires connect the piezoelectricity generators (or other types of electricity generators) to an electric contact to deliver the electricity generated by piezoelectricity generators (or other types of electricity generators) to a battery or other electricity-consuming devices.
